(19) United States
(12) Patent Application Publication
(10) Pub. No.: US 2002/0198978 A1
(43) Pub. Date: Dec. 26, 2002

(54) System to remotely control and monitor devices and data

(76) Inventor: Gregg S. Watkins, Scottsdale, AZ (US)

Correspondence Address: WEISS & MOY PC, 4204 NORTH BROWN AVENUE, SCOTTSDALE, AZ, 85251, US

(21) Appl. No.: 10/179,618

(22) Filed: Jun. 24, 2002

Related U.S. Application Data
(60) Provisional application No. 60/300,283, filed on Jun. 22, 2001.

(51) Int. Cl. G06F 15/173

(52) U.S. Cl. 709/223

(57) ABSTRACT

A system to remotely control and monitor devices and data uses a Remote Control Unit having a plurality of modules. A mainboard is the primary intersection point for integrating all the modules. A Power Supply System to provide power to the Remote Control Unit. One or more Communication Modules is used to transfer data to and from the Remote Control Unit. An Output Control Module is provided which receive signals from the mainboard to control operation of the devices. An Input Control Module is used to receive operation commands from push buttons or switches of the system. A Monitoring Input Module is provided which allows for the monitoring of both analog and digital data. An Operating System is programmed in the RCU. The OS manages the data received from monitored inputs, communication modules, other input modules, and local user interface, prepares and uploads data to the communications modules required to be sent out, performs various on and off functions of the outputs at required times, runs internal calculations for sunrise and sunset, date and time upkeep, and operates a display of a local user interface. A Remote User Interface (RUI) is used to send and receive commands and information to or from the system wherein information, data and commands may come directly from or to the RCUs, and a PC with Control and Monitoring Software (CMS) connected to the system.

### RELATED APPLICATIONS

This patent application is claiming the benefit of the U.S. Provisional Application having an application number of 60/300,283, filed Jun. 22, 2001, in the name of Gregg S. Watkins, and entitled “SYSTEM TO REMOTELY CONTROL AND MONITOR DEVICES”.

### BACKGROUND OF THE INVENTION

1. Field of the Invention

This invention relates to remote controls and, more specifically, to a system for remotely controlling devices and/or remotely monitoring devices and processes and/or remotely collecting data, and a related method to operate such a system. The control, monitoring, and/or collection of data can be applied to virtually anything such as devices, assets, digital data, analog data, processes, instrumentation, weather and environmental conditions, etc.

2. Description of the Prior Art

Generally, the process of remotely controlling and monitoring devices and data has been a manual and non-remote task requiring lots of man hours and travel time. For example, for controlling the operation and maintenance of a sports lighting system at a local park, parks personnel must go to the local park to turn on or off field lights, reset lighting time clocks, etc. Strides have been made in recent years to make the controlling and monitoring of devices a little more automated and remotely controlled. One way of achieving this is to utilize telephone lines and remote control and monitoring equipment, usually referred to as Remote Terminal Units (RTUs). The RTUs are generally very complex to use. These devices are not very user friendly and usually require an engineering type of person to use and operate them. There are some wireless methods which are utilized to remotely control and monitor devices and data, however, these methods are usually private networks installed by the user of the system. The problem with telephone lines and private wireless networks are that they are often very expensive to both install and operate due to trenching at remote locations, long wire runs, monthly operation fees, tower installation, maintenance, etc.

Some other recent developments in the area of wireless remote control and monitoring of devices and data involve the use of “Subscriber Software” installed on a customers PC and a connection to a “Host Computer System”. The “Host” computer then communicates and controls the devices and data and generally holds any data related to the system. Communication to the “Host” computer is the primary method of control of the devices and data for the user. The problem with this system and method is that many users often prefer to be able to control their devices and data from their own PC without having to rely on a remotely located Host-type system that many users access. Furthermore, most users would generally prefer to have their own data related to their system on a PC of their own rather than having the data on someone else's computer.

Systems that are currently available to perform remote control and monitoring generally have some sort of controlling mechanism which is usually a PC. If there is telephone access to the system and/or devices and data, this access is generally limited and provides override functionality only.

Presently, there are devices and products that allow for automated control of operation and maintenance of facilities. For example, there are short-range remote control, time clocks, industrial automation, home automation systems, building energy management systems, lighting control systems, sprinkler controllers and systems, alarm systems, and wired and wireless monitoring applications (e.g. weather stations). However, these systems do not allow for the public-accessible long-range wireless remote controlling and monitoring of devices and data; including the ability to be operated (monitored, programmed and controlled) on a stand-alone basis with a touch tone telephone access operating system

Short range remote control devices require that the user be in the general vicinity of the equipment to be controlled. There are no current systems geared towards long-range remote control, including the use of long-range wireless communication systems, and which utilizes short-range wireless methods generally as optional and/or enhancing equipment.

Time clocks are simple devices which are used to record starting and ending operation times. Time clocks are not meant to be accessible remotely (long range), cannot effectively handle varying schedules and have no monitoring capabilities.

Industrial automation systems are composed of user interfaces on computers as control centers (CC) along with microprocessor based controllers (RTUs) which perform controlling, switching and monitoring tasks. However industrial automation systems are used to control and monitor devices and processes within the locale of the CC controlling the system. The CC of the IAS is generally connected to the RTUs by a series of wires transmitting data serially. If a wireless system is used, it is short-range only. If remote control of the RTUs is desired, short-range wireless would be employed.

Home automation systems (HAS) have similar characteristics and problems to industrial automation systems (IAS) although they are normally not near as sophisticated as IAS. HOS have a computer and user interface as the control center (CC) and remote switching modules (either low-voltage switched, short-range wireless or X10 based, or some combination thereof) located around the house that control lights, air conditioning and heating, etc. However, the problems that are associated with IAS are also associated with HOS.

Building energy management system are used to control the Heating Ventilating and Air Conditioning (HVAC)of a building. Building energy management systems have similarities to both IAS and HOS and thus have the same problems associated with them.

There exist some lighting control systems (similar to building management systems) which incorporate microprocessor-based controllers, switching mechanisms, computer-based user interfaces, remote access, etc. However, the lighting control systems do not allow for complete wireless control and/or monitoring from a remote location.

Sprinkler systems generally send low-voltage power to solenoids of electronic water valves, and as such are extremely specific in scope. The present system is different in that it is extremely flexible and can send power out (virtually any voltage specified by the user), simply close dry-contacts to control devices, or send digital data out controlling devices digitally. Additional capabilities such as warn-off and delay-off (good for sport lighting applications), etc. are easily achieved by the ability of the operating system to be able to change the characteristics of the outputs to suit the needs of the application; the sprinkler system does not do this.

Additionally, on more sophisticated sprinkler systems that have remote access capabilities, such access is performed in one manner; where the present system differs in that it is designed for a multitude of communications methods without changing the basic method of operation. The remote access method is generally by telephone line or a private wireless network; the present system is different in that it uses a public accessible/subscribable wireless network. Also, where it would be very difficult for the sprinkler system to control lights that require schedule changes often (e.g. sport field lighting) due to current user interfaces and operating systems within those systems. The present system is therefore different because it is able to adapt to a variety of applications due to its unique operating system. And finally, the primary control of the sprinkler system is at the control unit itself or at a central computer system (for more sophisticated systems) and if a telephone or other hand-held device is used, it is for override purposes only; the present system is different in that it has a powerful method of operation by telephone which not only performs override duties, but also gives the user virtually the same functionality as they would have using a computer or other user interface device.

Alarm systems appear to have similarities in that there are some that have wireless access, but their purpose is not to remotely switch (remote control) any devices. Any devices (alarms) activated are triggered and/or controlled by the system at the site. Monitored data is very specific relating to alarm conditions. Remote access via telephone is generally to listen in on activity, which is real-time voice based and beyond the scope of the present invention. The primary difference though between an alarm system and the present system is the presence of, a full-featured operating system controllable via telephone as is described for the present system.

There exist many monitoring applications which monitor devices such as weather instrumentation, fluid levels in wells, environmental conditions, etc. In general, these systems are monitoring only and do not have an aspect of remote control to them. They generally utilize one type of communication system, where the present system is designed to be extremely flexible with regard to what communication system is used.

Therefore, a need existed to provide a system to remotely control and monitor devices and data that overcomes the problems associated with the prior art systems.

### SUMMARY OF THE INVENTION

In accordance with one embodiment of the present invention, it is an object of the present invention to provide a system to remotely control and monitor devices and data that overcomes the problems associated with the prior art systems.

### BRIEF DESCRIPTION OF THE EMBODIMENTS

In accordance with one embodiment of the present invention a system to remotely control and monitor devices and data is disclosed. The system uses a Remote Control Unit having a plurality of modules. A mainboard is the primary intersection point for integrating all the modules. The modules may be integrated with the mainboard on a ‘plug-in’ basis, hard-wired or wirelessly connected. A Power Supply System to provide power to the Remote Control Unit. One or more Communication Modules is used to transfer data to and from the Remote Control Unit. An Output Control Module is provided which receive signals from the mainboard to control operation of the devices. An Input Control Module is used to receive operation commands from push buttons or switches of the system. A Monitoring Input Module is provided which allows for the monitoring of both analog and digital data. An Operating System (OS) is programmed in the RCU. The OS manages the data received from monitored inputs, communication modules, other input modules including consumer codes (PINS) entered via keypad or smartcard, etc., and local user interface(s), prepares and uploads data to the communications modules required to be sent out, performs various on and off functions of the outputs at required times, runs internal calculations for sunrise and sunset, date and time upkeep, and operates a display of a local user interface(s). A Remote User Interface (RUI) is used to send and receive commands and information to or from the system wherein information, data and commands may come directly from or to the RCUs, and a PC with Control and Monitoring Software (CMS) connected to the system.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of the Remote Control Unit (RCU) used in the present invention.

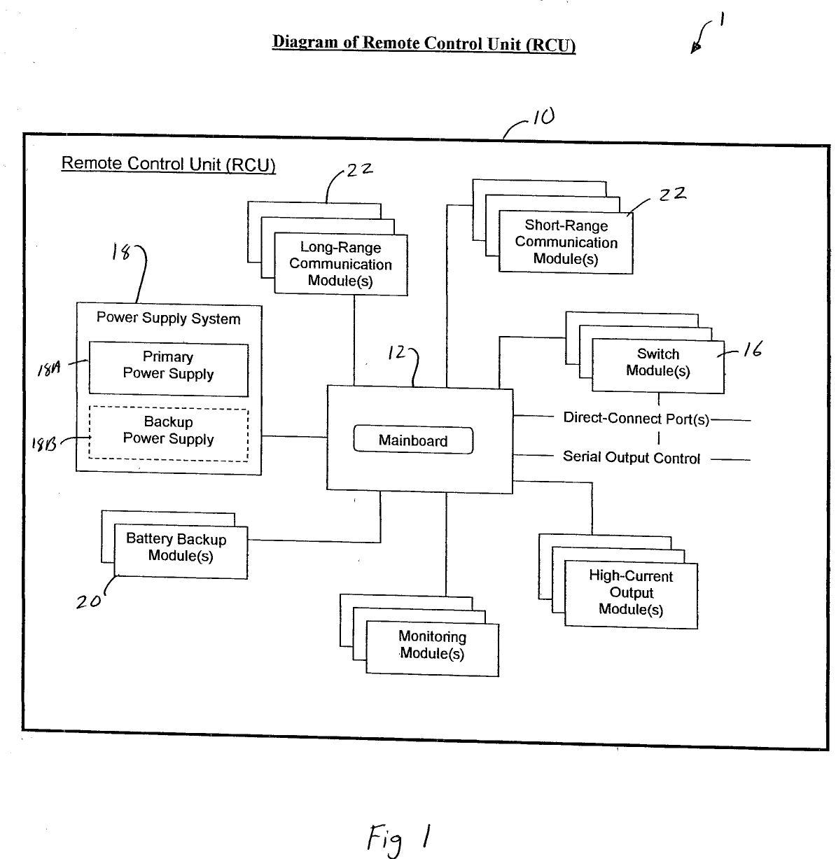

FIG. 2 is a simplified diagram of the mainboard of the RCU depicted in FIG. 1.

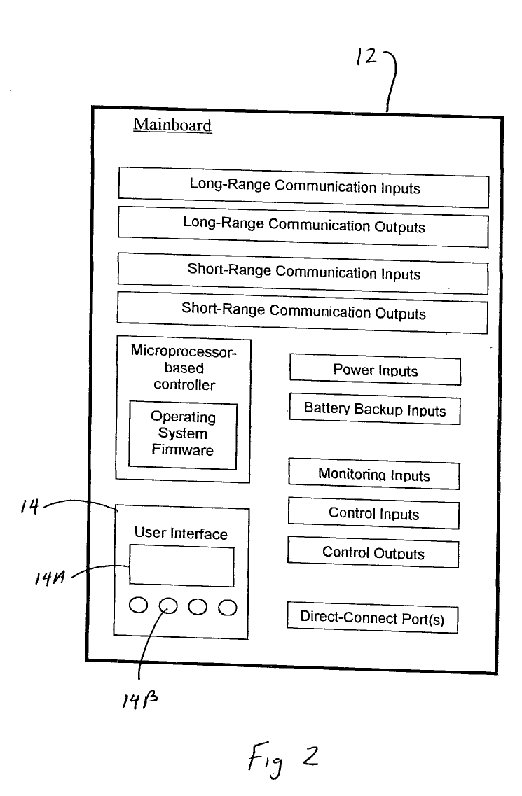

FIG. 3 is a simplified functional block diagram of a remote site using the RCU of the present invention.

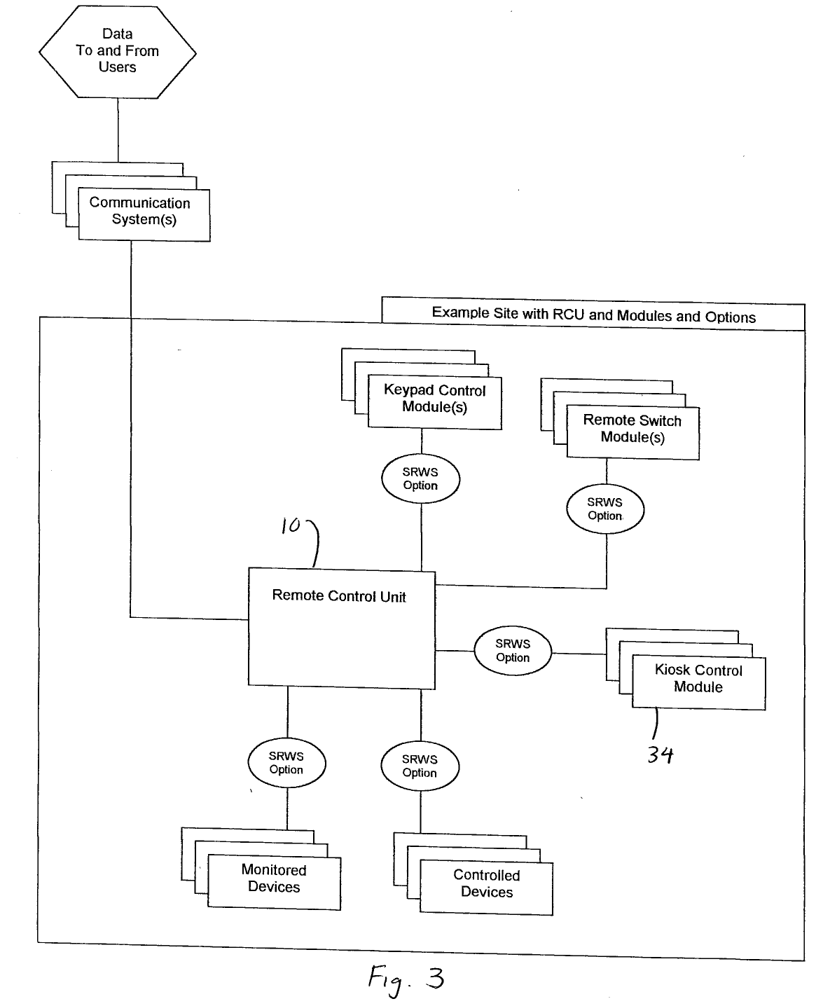

FIG. 4 is a simplified function block diagram of a short range wireless embodiment of the present invention.

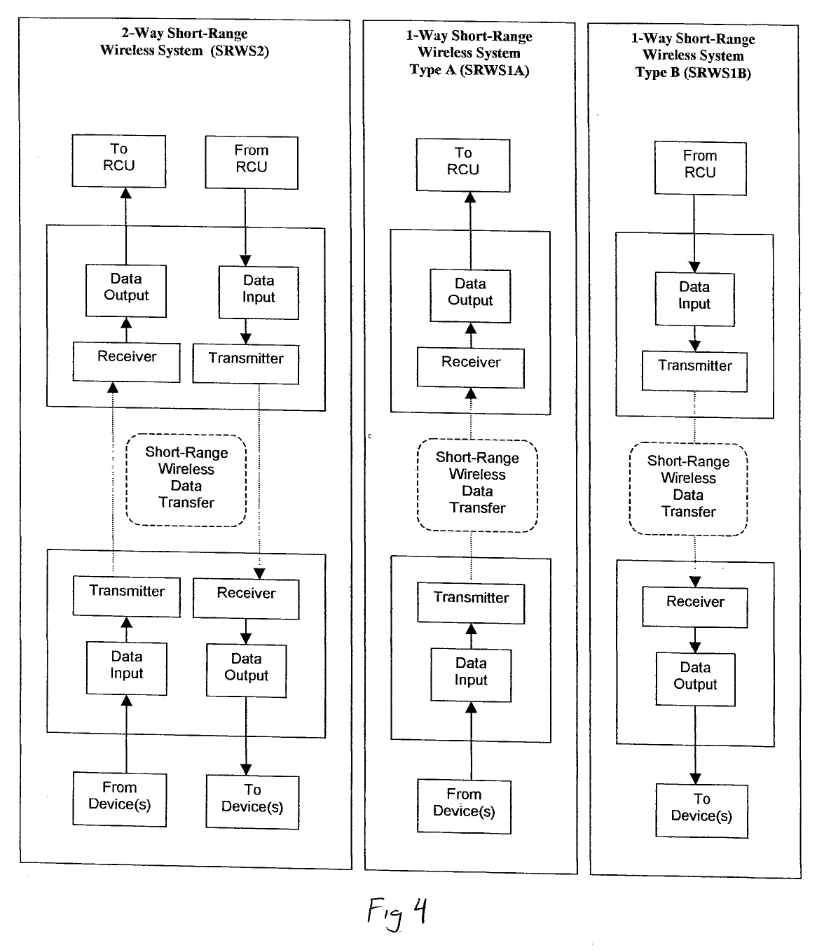

FIG. 5 is a flowchart depicting the operation of the system of the resent invention.

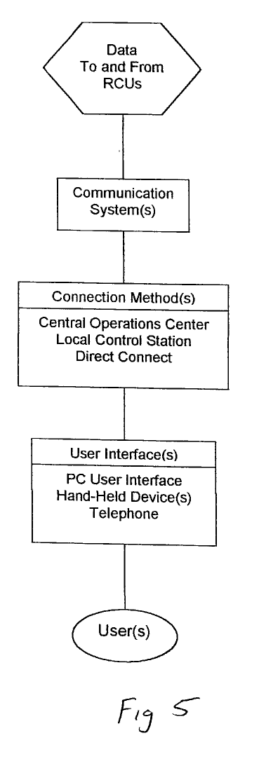

FIG. 6 is a flowchart depicting the operation of the system of the resent invention.

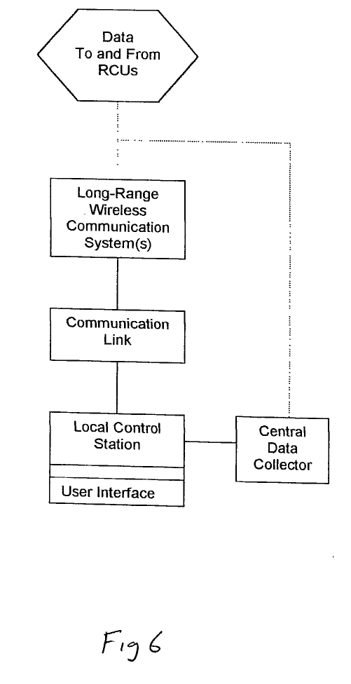

### DETAILED DESCRIPTION OF THE PREFERRED EMBODIMENT

Referring to the Figures, a system to remotely control and monitor devices and data 1 uses a remote control unit 10 (hereinafter RCU 10). The RCU 10 is designed to be extremely modular for easily adaptation for various markets and applications. The RCU 10 has a plurality of modules. Each of the modules are coupled to a mainboard 12, generally by being either wired or plugged-in, or wirelessly via a wireless communication module. Some of the modules of the RCU 10 are included in the main housing of the RCU 10 while others may be physically located outside of the RCU 10.

The RCU 10 may have one or more Local User Interface(s) 14. The Local User Interface 14 allows users to interact with the operating system of the RCU 10 and makes available any of its capabilities that would be desirable in an on-site walk-up mode. The Local User Interface 14 includes a display 14A. The display 14A may be an LCD screen or the like. A plurality of push buttons 14B are also located on the Local User Interface 14 to program and control the RCU 10. The Local User Interface 14 allows users to interact with the RCU 10 at the site to perform such tasks as program unit to perform activity, enter time schedules, read diagnostics of unit, view activity, perform walk-up command of unit, etc.

A Manual Control Switch Module 16 may also be part of the RCU 10. The Manual Control Switch Module 16 provides switches and related LED indicators (or other such indicators)that interface with the output modules that eventually control devices, or may control the devices directly. The switches may be in the form of dial-type or push-button type and are usually provided for Off-Auto-Hand (in that specific order) control of the output/devices they control and/or a timed-on function. The LED indicators show status of the switches and/or outputs/devices. They are provided with the capability of momentary or continual operation and may be of the shorting or non-shorting type. Also, additional momentary-action switches provide for walk-up control of outputs/devices whereby activating these switches causes the controlled devices to be activated for a predetermined time duration (time duration set via OpCode or at local user interface 14).

A Power Supply System (PSS) 18 is used to provide power to the RCU 10. The PSS 18 includes at least one power supply 18A, with RCU circuitry designed for an optional power supply 18B as a back-up redundant power supply. Each is monitored for on/off, failure, etc. status and such statuses are indicated via LED indicator and/or LCD display; also such statuses are sent to various destinations to report to users, if a 2-way communications module is utilized.

A Battery Backup System (BBS) 20 is also provided in the RCU 10. The RCU includes 3 levels of battery backup. Each is monitored for charge, failure, etc. Status and such statuses are indicated via LED indicator and/or LCD display. Also such statuses are sent to various destinations to report to users, if a 2-way communications module is utilized. The RCU includes battery backup of RAM, EEPROM, etc. which serves to keep details such as on/off schedules, logged info, and other internal data backed up in case of power failure in addition to keeping the internal microprocessor operating at a minimal level to keep the unit ‘alive’. The RCU circuitry provides for optional battery backup (rechargeable) of unit which provides for full functionality of unit including switching the outputs to their respective states if so commanded by the RCU controller and performing any monitoring tasks dictated by the unit and/or related inputs, and of course powering the communication module. Additionally, the RCU circuitry provides for optional battery backup (rechargeable) that provides power to the communications module only; thus allowing for schedules, monitored data, and/or any other commands or data being sent to the RCU 10 to be received into the main controller of the RCU 10.

The RCU 10 has one or more Communication Modules 22. The RCU 10 is designed with circuitry to operate, accept input of data from, and provide output of data to 1 or more communication modules 22. Because of the mainboard's 12 ability to accept communication from multiple communication modules, several unique capabilities may be a achieved and include: factory only access to users system, emergency access, airwave traffic load splitting and management, backup receivers and transmitter capability, etc. Such modules may be virtually any device that provides communication of data into and/or from the RCU 10 generally in the form of serial data. The communication module(s) 22 provides the remote sending and/or receiving of data (and remote control and monitoring) capability for the RCU 10. Generally the communication module(s) 22 are wireless devices, but a direct telephone line or other direct wire system may be used. Examples of communication modules 22 are 1way paging data receivers, 2-way paging data receivers/transmitters, cellular telephone, satellite based radio electronics, etc.

The RCU 12 has a Multiple-Frequency Communication Module 24. Because of the inclusion of Multiple-Frequency Communication Modules 24, several unique capabilities may be a achieved and include: factory only access to users system, emergency access, airwave traffic load splitting and management, backup receivers and transmitter capability, etc.

An Atomic Clock Receiver 26 may be included to maintain time automatically. Other items required to keep time for the given location of the RCU 10 such as Time Zone and Daylight Savings observance are processed by the OS of the system.

An Output Control Module (OCM) 28 is generally comprised of relays which receive signals from the mainboard 12 or from a wireless communication module(s) if wirelessly connected to mainboard 12 to control the operation of device(s). This control may be accomplished in a number of ways including directly controlling electric loads by either supplying power to turn devices ‘on’ or cutting power to turn devices ‘off’. Often the OCM 28 is not directly controlling the final load/device, as in the case of lighting contractors which after being activated by the OCM 28 subsequently send current to the lighting circuits to which they are connected, or in the case of simply opening or closing a circuit for dry contact inputs in other control devices. The OCM 28 may also be comprised of other electronics to control devices which require something other than single voltage or dry contact for control such as variable voltage control, other analog control or digital control.

An Input Control Module (ICM) 30 is comprised of dry-contact inputs to receive operation commands from push buttons or switches. The ICM 30 also has multiple input jacks to receive control commands from other devices such as a keypad, monitoring module, etc. with this information in turn passed to the mainboard 12 as serial data into an appropriate serial input on the mainboard 12. The ICM may be connected to the mainboard via hardwired, plug-in, or wirelessly via a wireless communication module.

A Monitoring Input Module (MIM) 32 contains electronics allowing for the monitoring of both analog and digital data. The MIM 32 has circuitry for accepting input from weather information, fluid level, power and current activity, pressure, motion sensors, etc. and is built out depending on the application. The MIM may be connected to the mainboard via hardwired, plug-in, or wirelessly via a wireless communication module.

The mainboard 12 is the primary intersection point for integrating all the modules comprising the system. The mainboard 12 houses primarily the main microprocessor-based controller, real-time-clock, RAM battery backup, local user interface components, inputs for various modules such as the communication module, MIM, PSS, etc. and outputs for OCMs and communication modules, port for downloading info from controller such as logged info, and main power switch.

The RCU 12 also has the capability to lock out certain circuits and outputs based on activity of other circuits and outputs (for example an output controlling sprinklers on a sport field may be disabled if an output controlling lights on the playfield are active) . The RCU 12 also has the capability to activate certain circuits and outputs based on activity of other circuits and outputs (for example an output controlling a warning bell/recording/lights may be activated based upon the near turning ‘off’ of an output controlling the lights on a playfield), referred to as a warn-off feature.

The system includes an optional keypad as an additional local user interface/input module which allows for the control of the RCU 12 from remote location (but near) the RCU 12. The Keypad may be connected by wires or by short-range wireless option. A key use of the Keypad would be for the confirmation of use of devices by a consumer such as the a consumer of a lighted sport field facility arriving at the facility and entering a code (PIN) given to him by the owner of the facility (a city parks and recreation department), at which time the lights would then be activated for the consumers use and this use logged in the RCU 10 memory for reporting purposes, etc.

A Kiosk Command Center (KCC) 34 allows similar functionality as the Keypad but in an expanded format. The KCC 34 would have a more robust user interface and perhaps its own mounting pedestal if desired, etc. It too may be wired or wireless to the RCU 12.

The Operating System (OS) 36 is firmware that makes the RCU 12 function. It manages the data received from monitored inputs, communication modules, other input modules, local user interface; it prepares and uploads data to the communications modules 22 required to be sent out; it performs the various on and off functions of the outputs at the required times; it runs internal calculations for sunrise and sunset, date and time upkeep, etc.; and operates the display of the local user interface 14.

The communication system 36 is the infrastructure that facilitates the transmitting and/or receiving of data from one point to another for any given communication module 22. In general, these infrastructures are public networks available to end user via a subscription fee such as paging or cellular telephone services; however, private networks may be utilized such as police, fire and other privately installed transmitters, receivers, repeaters, towers, etc. that goes into a communication infrastructure.

A communications link maybe necessary in wireless systems and is the means by which the user sends and receives commands and data to/from the communications (wireless) infrastructure. Often this link is a telephone line such as the way that users access a pager system via touch-tone type telephone. In the case of pagers, a user uses a telephone to enter digits via touch-tones and the telephone line leads to a central location that then subsequently sends or enters this information into the wireless system. In cases where the use has direct access to the communication system, then a communications link is not necessary. Such a case would be when a person uses a cellular phone to call another user on the same system. Direct access would also occur if the RCUs communication module accepts input from an ordinary telephone line, and user would use a telephone to access the RCU.

A Remote User Interface (RUI) 40 is the means by which a user of the system sends or receives commands and information to/from the system. Information, data and commands may come directly from/to the RCUs 10 or may come from/to a PC with Control and Monitoring Software (CMS) connected to the system serving as a ‘middle-man’ between the RUI 40 and the RCUs 10.

A PC with Control and Monitoring Software (CMS) is used by the user to enter schedules, set up and program RCUs 10, get monitored data, etc. The CMS sends/receives the information to the communications system via the communication link to which the CMS is connected. The communications system sends/receives information to/from the communication modules of the RCUs 10.

A Touch-Tone Telephone (TTT) can be used to control the system in several ways. A TTT can be used to access the CMS via a telephone interface module to send and receive data to the system. A TTT may be used to send data directly to the communication system which in turn sends data wirelessly to the RCUs 12. In the case of RCUs which have a telephone line attached, a TTT may be used to access the RCU directly.

A Hand Held Device (HHD) such as a PDA, 2-way messaging pagers, WAP enabled cellular phones, etc. may be used to enter and receive data to/from the system. The HHD may communicate with the CMS or with the communications system (virtual direct to the RCUs). Depending on the HHD utilized, the HHD may have special user interface software making the inputting and extraction of data easy for the user.

A Voice Activation Interface (VAI) may either be a module incorporated with the CMS or a module located at central operations center to be accessed by multiple users. In either case, the VAI can be accessed via telephone and will respond to voice commands from the user.

A Telephone Interface Module (TIM) may either be a module incorporated with the CMS or a module located at a central operations center to be accessed by multiple users. In either case, the TIM can be accessed via telephone and will respond to touch-tone commands entered by a user utilizing a touch-tone telephone.

A Central Operations Center (COC) serves as a central location whereby a multitude of users can access a master interface to the system. There would be a computer housed at the COC which would be connected to communication links (via internet, telephone line, etc.) required by the users of the system. The COC serves as both a general use facility for those users of the system that access the master interface as their primary interface to the system, and as a backup interface to the system in cases where the users' system goes down.

A Central Data Collector (CDC) is a wireless device or multitude of wireless devices located at the site of the CMS and connected to the CMS. The CDC is tuned to the frequency or frequencies currently in operation for any given user's system and collects data sent out to the RCUs 10 from any remote user interface on the system. The data can then be used for reporting purposes and/or verification of signals sent. For example, users turning on lights from a telephone can be assured that the CDC will collect those signals so that when a report showing the hours of light usage is prepared, such report will include the telephone directed commands in addition to those perhaps sent via the CMS. Additionally, commands sent out via the CMS can be compared with those received by the CDC for accuracy, and resent if accuracy is less than adequate. Normally the CDC would be utilized on basically 1-way systems (RCUs 10 that only receive data, but do not transmit data). The CDC is generally not necessary on 2-way systems because the data ‘actually’ received by the RCU can be transmitted back to the CMS for data warehousing and processing, but a CDC may still be used on a 2-way system to facilitate the transfer of data to a PC.

The operating system (often known as firmware) of the system is programmed onto a module of the mainboard and may be replaced easily with upgraded modules without great effort or negative effect on existing modules. Some upgrades may be transferred to the OS over-the-air, and/or transferred by direct connect via a port in the RCU. The operating system module is generally in the form of an EEPROM (or other similar memory chip) or included on a small controller module that easily plugs into the mainboard. The OS handles all of the internal workings, function and maintenance routines of the RCU 10. The OS also handles and manages all of the input data and commands from communication modules, input control modules, monitoring modules, etc.; and all of the output data and commands to the output control modules, serial data output, etc.

The OS is designed so that the outputs are easily programmable and changeable by several methods including: 1) Direct from PC, 2) Over-The-Air in the form of OpCodes, 3) local user interface, 4) direct connect port of RCU, and 5)in some cases dipswitches. In general, the system utilizes and offers up to 64 outputs, but the number of outputs is virtually endless with idea of add-on output modules. The outputs generally are supplied in the form of relays/contractors or serial data output. The outputs may be grouped together to form zones. Each output may belong to more than one zone. The outputs may be programmed to be normally-open, normally-closed, pulsed, etc. regarding the electrical functionality—all totally flexible and programmable. The outputs may be programmed to perform a function based on the operation of another output or zone, as would be in the case of ‘lock-out’, ‘warn-off’, and ‘delay-off’ functionality, etc. They may be set to operate for an on and off routine once the output or zone is activated as would be the case for an alarm wherein a horn is set to turn on and off multiple times, etc.

The OS accepts input from the communication modules and performs all of the necessary routines to make the OpCodes, as defined in the Touch-Tone Telephone Operating Method, function properly.

The OS accepts input from many other methods and makes use of the ‘OpCode’ internal architecture (not necessarily the external command structure). These methods include: 1)a local user interface, 2)Keypad Control, 3)Kiosk Control 4)Remote Switches, etc.

There are standard mathematical formulae available in the public domain which calculate Sunrise and Sunset times, with longitude and latitude required to process the calculation. These formulae generally output Sunrise and Sunset times in Greenwich Mean Time. This OS incorporates logic utilizing a standard formula for calculating Sunrise and Sunset times. This OS accepts Longitude and Latitude, Daylight Savings flags and Time Zone information OTA (or may be programmed directly from PC) which will be used in the calculation of Sunrise or Sunset for any given location of an RCU. The OS then utilizes the sunrise and sunset calculations output from this standard formula and adds or subtracts an offset dictated by the user of the system. This offset ranges from zero seconds to 999 minutes. The purpose of the offset is to adjust the on and off time of devices to a more flexible and appropriate time desired by the user. An example of the use of this feature is the setting of parking lot lights to come on at 15 minutes before sunset and off at 30 minutes after sunrise. In addition to a real time clock circuit, an optional RF circuit for receiving the atomic clock signals from Colorado are included for added accuracy and ease of maintenance.

Method to Operate via Touch-Tone Telephone . . .

In order to program the RCU 10, some definitions are first given:

UID=Unit I.D.

GID=Group I.D.

All-Zone ID=a number or numbers (defined by factory) that mean ‘affect all zones’ used within a Command String.

UZC (Unit Zone Combo)=a UID with an All-Zone ID, or a UID with a single Zone ID, or a GID, or a GID and single Zone ID.

Command String=the string of digits that follow an OpCode.

OTA=Over The Air

UD=User Defined

Below, are described some common OpCodes used in the RCU 10.

Unit I.D. Numbers

Set UTD OTA and UD.

UID may be variable in length and set OTA and UD

Group I.D. Numbers

Set GID OTA and UD

GID includes unit and zone

Passcodes

Set Passcode OTA and UD, including set security level associated. Passcode may be variable in length and set OTA and UD (may be set to zero to mean no passcode necessary in command string)

OpCode Security Level

OpCodes have a security level associated with them and only passcodes with the same security level or better can affect a given OpCode.

The OpCode security level is set OTA and UD

Set Longitude/Latitude/DST observation/Time Zone OTA for sunrise/sunset calculator to use.

Schedules By Date

Mini—sets a UZC to activate immediately and deactivate at a specified desired time on the same date (today). Includes and OpCode to delete. This OpCode provides immediate Switch-On-Demand capability to the Unit.

Short—sets a UZC to activate at a specified desired time and deactivate at a specified desired time on the same date (today). Includes and OpCode to delete.

Medium—sets a UZC to activate at a specified desired time and deactivate at a specified desired time, both on the same date as specified by the user. Also includes a schedule number so that deletions or updates may occur. Includes and OpCode to delete.

Long—sets a UZC to activate at a specified desired date/time combo, and deactivate at a specified desired date/time combo. Also includes a schedule number so that deletions or updates may occur. Includes and OpCode to delete.

Separate OpCodes for computer use only (automation) are employed for the setting of Medium and Long schedules so that computer (or automation) does not interfere with those using only a telephone on the same system. In other words, one may use a telephone to set Medium and Long schedules for a given system and said system may also have a computer setting Medium and Long schedules; but different OpCodes will be utilized and the schedules will not interfere with each other nor get cancelled out by each other.

General Notes Regarding Schedules: Schedules can be overridden by Override OpCodes, whereby the Override OpCodes have priority.

Repeat Schedules

Set schedules to repeat based upon the following protocols:

Method 1 Multiple Days: CC ZZ DDDDDDD TTTT(x) TTTT(x) NN

Where:

CC=OpCode

ZZ=Zone or All-Zone ID

D=the first D is Sunday (or Monday, this is user defined) and the second D is Monday, third D is Tuesday, etc. Only 1's and 0's are used here, where a 0 means to not schedule and a 1 means to schedule.

T=the first set of T's is the on time in 24 hr time format (or 12 hr time format with x=0 for am and x=1 for pm, this is user defined) and the second set of T's is the off time.

N=Schedule number so that multiple schedules may be made but later referenced by the NN in order to change or delete.

EXAMPLE=CC 03 0101010 1800 2345 02 means to turn zone 3 on at 6:00 pm and off at 11:45 pm on Monday, Wednesday and Friday. This schedule has a schedule number of 02.

Method 2 Multiple Days: CC ZZ DDDDDDD TTTT(x) TTTT(x) NN

Where:

CC=OpCode

ZZ=Zone or All-Zone ID

D=the day of the week represented by a number (1 for Sunday, or alternatively 1 for Monday, this is user defined) 2 for Monday, etc., to be included in the schedule. Days not included are omitted or represented by 0. There must be 7 digits entered here, but order is irrelevant. After entering the days to be included in schedule, enter 0's to makeup a total of seven digits.

T=the first set of T's is the on time in 24 hr time format (or 12 hr time format with x=0 for am and x=1 for pm, this is user defined) and the second set of T's is the off time. N=Schedule number so that multiple schedules may be made but later referenced by the NN in order to change or delete. EXAMPLE=CC 02 613500 1800 2345 05 means to turn zone 2 on at 6:00 pm and off at 11:45 pm on Monday, Wednesday, Friday and Saturday. This schedule has a schedule number of 05. An entry of 135600 for D's would yield the same results. An entry of 1356 would be incorrect.

Method 3 Multiple Days: CC ZZ D1-Dn 8 TTTT(x) TTTT(x) NN

Where:

CC=OpCode

ZZ=Zone or All-Zone ID

D1-Dn=the day of the week represented by a number (1 for Sunday, or alternatively 1 for Monday, this is user defined) 2 for Monday, etc., to be included in the schedule. Only 1 through 7 are valid characters here to represent the days. After entering the days to be included in schedule (the order is irrelevant), enter 8 to indicate that all days have been entered. 8=indicates that all days to be included in schedule have been entered.

T=the first set of T's is the on time in 24 hr time format (or 12 hr time format with x=0 for am and x=1 for pm, this is user defined) and the second set of T's is the off time. N=Schedule number so that multiple schedules may be made but later referenced by the NN in order to change or delete.

EXAMPLE=CC 02 247 8 1800 2345 05 means to turn zone 2 on at 6:00 pm and off at 11:45 pm on Tuesday, Thursday and Sunday. This schedule has a schedule number of 05. An entry of 724 for D's would yield the same results. An entry of 2470000 would be incorrect.

Method 4 Multiple Days: CC ZZ D TTTT(x) TTTT(x) NN

Where:

CC=OpCode

ZZ=Zone or All-Zone ID

D=the day or days of the week represented by a number, which has been previously defined by the user via OpCode and OTA, to be included in the schedule.

T=the first set of T's is the on time in 24 hr time format (or 12 hr time format with x=0 for am and x=1 for pm, this is user defined) and the second set of T's is the off time. N=Schedule number so that multiple schedules may be made but later referenced by the NN in order to change or delete.

EXAMPLE =CC 02 5 1800 2345 05 means to turn zone 2 on at 6:00 pm and off at 11:45 pm on Monday, Wednesday, Friday (5=M-W-F as previously defined by the user). This schedule has a schedule number of 05.

Method 1 Single Day: CC ZZ D TTTT(x) TTTT(x) NN

Where:

CC=OpCode

ZZ=Zone or All-Zone ID

D=the day of the week represented by a number (1 for Sunday, or alternatively 1 for Monday, this is user defined) 2 for Monday, etc., to be included in the schedule. Only 1 through 7 are valid characters here.

T=the first set of T's is the on time in 24 hr time format (or 12 hr time format with x=0 for am and x=1 for pm, this is user defined) and the second set of T's is the off time. N=Schedule number so that multiple schedules may be made but later referenced by the NN in order to change or delete.

EXAMPLE=CC 02 3 1800 2345 05 means to turn zone 2 on at 6:00 pm and off at 11:45 pm on Wednesdays. This schedule has a schedule number of 05.

Computer (automated) generated repeat schedules follow the same format as Method 1—Single Day, but are set under separate OpCode to keep from being altered accidentally by those setting via telephone.

Note: All of the above repeating schedules repeat weekly. A repeat end date may be specified in the future. There are OpCodes to delete each of the above schedules.

Overrides

Override For a Duration of Time—Overrides (either activate or de-activate) any schedules for the UZC specified within the command string for a duration of time specified by the command string. The duration of time is currently defined by a number of 30 -minute increments, but in the future any duration may be used (1 hr increments, minutes, etc.) At the end of the time duration, the UZC affected will revert to schedules (go back to normal operation). This OpCode provides immediate Switch-On-Demand capability to the Unit. Good for adding minutes to schedules in cases of overtime games, etc. Good for turning off lights in cases of early terminating games or no-shows.

Override Until a Specified Time—Overrides (either activate or de-activate) any schedules for the UZC specified within the command string until a time specified by the command string. At the end of the specified time, the UZC affected will revert to schedules (go back to normal operation). This OpCode provides immediate Switch-On-Demand capability to the Unit. Good for adding minutes to schedules in cases of overtime games, etc. Good for turning off lights in cases of early terminating games or no-shows.

Override For a Duration of Time (ALL ZONES)—Overrides (either activate or de-activate) any schedules for all zones of the UZC specified within the command string for a duration of time specified by the command string. The duration of time is currently defined by a number of 30-minute increments, but in the future any duration may be used (1 hr increments, minutes, etc.) At the end of the time duration, the UZC affected will revert to schedules (go back to normal operation). This OpCode provides immediate Switch-On-Demand capability to the Unit. Good for Rainouts.

Override Until a Specified Time (ALL ZONES)—Overrides (either activate or de-activate) any schedules for all zones of the UZC specified within the command string until a time specified by the command string. At the end of the specified time, the UZC affected will revert to schedules (go back to normal operation) . This OpCode provides immediate Switch-On-Demand capability to the Unit. Good for Rainouts.

General Notes on Overrides—Overrides have priority over all schedules within the unit, and upon the completion or expiration of the override(s), any schedules within the unit that are active will take effect.

Force On/Off—A force On or Off time range (for example midnight to sunrise) may be set by the user OTA and UD, during which zones will be in a state defined by the user (normally deactivated or “Off”). This OpCode may either be overridden by Override OpCodes or not as decided by the user OTA and UD. Good as a light curfew whereby lights cannot be on during this time.

Clearing OpCodes

Clear Schedule data

Clear Override data

Clear Error Log

Coded Use/Use Confirmation OpCode

OpCode used by users of equipment (RCU and Zone combo) to confirm that they need the schedules sent to a respective RCU/Zone to activate.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A system to remotely control and monitor devices and data comprising, in combination:
a Remote Control Unit having a plurality of modules;
a mainboard is the primary intersection point for integrating all the modules;
a Power Supply System to provide power to the Remote Control Unit;
one or more Communication Modules to transfer data to and from the Remote Control Unit;
an Output Control Module which receive signals from the mainboard to control operation of the devices;
an Input Control Module to receive operation commands from push buttons or switches of the system;
a Monitoring Input Module which allows for the monitoring of both analog and digital data;
an Operating System in the RCU which manages the data received from monitored inputs, communication modules, other input modules, and local user interface, prepares and uploads data to the communications modules required to be sent out, performs various on and off functions of the outputs at required times, runs internal calculations for sunrise and sunset, date and time upkeep, and operates a display of a local user interface; and
a Remote User Interface (RUI) to send and receive commands and information to or from the system wherein information, data and commands may come directly from or to the RCUs, and a PC with Control and Monitoring Software (CMS) connected to the system.

2. The system of claim 1 further comprising a Local User Interface which allows users to interact with the operating system of the RTU and make available any of the system capabilities that would be desirable in an on-site walk-up mode.

3. The system of claim 2 wherein the Local User Interface comprises:
a display; and
a plurality of input buttons located on the Local User Interface to program and control the RCU.

4. The system of claim 1 further comprising a Manual Control Switch Module that interface with the output modules to control the devices.

5. The system of claim 1 further comprising a Battery Backup System (BBS)in the RCU.

6. The system of claim 1 further comprising a PC with Control and Monitoring Software (CMS) for use by a user to enter schedules, set up and program the RCU, and get monitored data.

7. The system of claim 6 further comprising a Touch-Tone Telephone (TTT) to control the system by accessing the CMS via a telephone interface module to send and receive data to the system.

8. The system of claim 7 further comprising a Hand Held Device (HHD to enter and receive data to/from the system.

9. The system of claim 6 further comprising a Voice Activation Interface (VAI) to be accessed via telephone and will respond to voice commands from the user.

10. The system of claim 6 further comprising a Telephone Interface Module (TIM) to be accessed via telephone and will respond to touch-tone commands entered by a user utilizing a touch-tone telephone.

11. The system of claim 1 further comprising a keypad for local user interface to allow for the control of the RCU from remote location near the RCU.

12. The system of claim 11 wherein the keypad allows for the confirmation of use of devices by a user by entering a code.
